(19) United States
(12) Patent Application Publication
(10) Pub. No.: US 2023/0289390 A1
(43) Pub. Date: Sep. 14, 2023

(54) DATA STORAGE COMPUTING DEVICE FOR KEYWORD BASED SEARCH AND CONTROL METHOD FOR USER COMPUTING DEVICE THEREOF

(71) Applicant: Sung Il KIM, Seoul (KR)

(72) Inventor: Sung Il KIM, Seoul (KR)

(21) Appl. No.: 18/052,200

(22) Filed: Nov. 2, 2022

(30) Foreign Application Priority Data
Mar. 10, 2022 (KR) 10-2022-0029921

(51) Int. Cl. G06F 16/9535; G06Q 30/0601

(52) U.S. Cl. CPC G06F 16/9535; G06Q 30/0601

(57) ABSTRACT

The present disclosure relates to a computing device and a control method for providing a search item, which includes a comparative industrial product not directly related to an industrial product as a search result, by providing the industrial product as a search keyword, the search item providing single information and comparative information.

### CROSS-REFERENCE TO RELATED APPLICATION

This application claims priority to Korean Patent Application No. 10-2022-0029921, filed on Mar. 10, 2022, and all the benefits accruing therefrom under 35 U.S.C. § 119, the contents of which are incorporated by reference in their entirety.

### BACKGROUND

The present disclosure relates to a computing device and a control method for providing single information and comparative information including a comparative industrial product not directly related thereto as a search result by providing the industrial product as a search keyword.

As a computing device become more common, there is a strong tendency to purchase the industrial product through a keyword based search online.

In addition, as a function of the industrial product is advanced, types of information that need to be collected about a purchase target to make a purchase decision are also continuously increasing. Accordingly, it takes a lot of time and effort to make a purchase decision, and it is not difficult to collect accurate information required for purchase.

In particular, as hardware competition among rival companies intensifies, a user or a buyer is demanding information between at least one industrial product that is a comparison target having the same or similar purpose of use or main configuration. Accordingly, as for information on industrial products, there is an increasing need to provide single information about one industrial product or comparative information about a plurality of industrial products.

Accordingly, there is a need for a technology that can effectively compare and collect various information and user opinions about one industrial product and a plurality of comparative industrial products to be compared, and lead to purchase in consideration of this.

### SUMMARY

The present disclosure provides a technical means for providing search information for not only an industrial product to be purchased but also a related comparative industrial product when a user searches for the industrial product to be purchased.

The present invention provides a computing device and a control method that provide a comparative industrial product not directly related to a search keyword as a search result.

The present invention provides a computing device and a control method that provide not only a search result for the industrial product that directly correspond to the search keyword, but also at least one comparative industrial product having the same as or similar to at least one of purpose of use or a main function with the search keyword, or corresponding to the search keyword.

The present invention provides a computing device and a control method for providing single information or comparative information about a comparative industrial product.

The present invention provides a computing device and a control method for providing comparative information about an industrial product and a comparative industrial product or a plurality of comparative industrial products.

The present invention provides a computing device and a control method for selecting and providing a product review or a comparative review that are previously input.

The present invention provides a computing device and a control method for effectively collecting and illustrating evaluations or opinions of various users for the industrial product and the comparative industrial product.

The technical problems to be achieved in the present disclosure are not limited to the technical problems mentioned above, and other technical problems not mentioned will be clearly understood by those of ordinary skill in the art to which the present disclosure belongs from the following description.

In accordance with an exemplary embodiment of the present invention, there is provided a control method for a user computing device that is connected to a data storage computing device including search information and performs a keyword based search, the method including receiving industrial product information about a predetermined industrial product as the search keyword, requesting the data storage computing device to search with the search keyword, and receiving a search result for the search request from the data storage computing device, in which the search result includes a search item including at least one comparative industrial product corresponding to the search keyword, and the comparative industrial product is an industrial product corresponding to the predetermined industrial product in terms of at least one of a purpose of use or a main configuration.

In the present disclosure, the industrial product information may be at least one of a name or a type or a specific category of the industrial product.

In the present disclosure, the comparative industrial product may be included in a higher category or higher type of the predetermined industrial product.

In the present disclosure, the search item may include a comparative preference displayed in a form of a visual chart or chart, and the comparative preference may be evaluation information for comparing the preference of the predetermined industrial product with at least one of the comparative industrial products or a plurality of the comparative industrial products.

In the present disclosure, the search item may include single information or comparative information, and the single information may include evaluation information about a single industrial product without a comparison target or a single comparative industrial product, and the comparative information may include evaluation information for comparing the predetermined industrial product with at least one of the comparative industrial products or a plurality of the comparative industrial products.

In the present disclosure, the single information may include at least one of specification information, a single preference, a product review, and a meeting room, and the comparative information may include at least one of specification comparison, a comparative preference, a comparative review, and a meeting room.

The present disclosure may further include receiving at least one of the comparative information or the single information.

In the present disclosure, the search result may be derived by reflecting at least one of the single information or the comparative information.

The present disclosure may further include outputting a meeting room where a message is exchanged with other participants.

In the present disclosure, the meeting room may include a message window that outputs the message of the participants of the meeting room in the form of a speech bubble, and, in the speech bubble of the participants, the preference input by the participant may also be displayed.

In accordance with another exemplary embodiment of the present invention, there is provided a control method for a user computing device for displaying a plurality of evaluation text for a predetermined industrial product and the number of consents for the evaluation articles, the method including displaying the number of consents to the evaluation text and a selection button for selecting with an indication of consent to the evaluation articles and reflecting, when the evaluation text is selected with the selection button, the number of consents of the selected evaluation text and displaying the evaluation text again, in which the evaluation text is a product review or comparative review for a search item selected from search items that are a search result corresponding to a search keyword for the predetermined industrial product, the comparative review is an evaluation text with a plurality of industrial products as a comparison, and the product review is an evaluation text for a single industrial product or a comparative industrial product.

In accordance with still another exemplary embodiment of the present invention, there is provided a data storage computing device connected to a user computing device and including search information, including a communication unit configured to exchange data with the user computing device, a storage unit configured to store the search information, and a control unit configured to perform a search using the search information, in which the control unit is configured to receive industrial product information about a predetermined industrial product as a search keyword from the user computing device, perform a search for the predetermined industrial product and a comparative industrial product of the predetermined industrial product, and provide a search result for the search keyword to the user computing device, the search result includes a search item including at least one of the comparative industrial products corresponding to the search keyword, and the comparative industrial product is an industrial product corresponding to the predetermined industrial product in terms of at least one of a purpose of use or a main configuration.

In accordance with still another exemplary embodiment of the present invention, there is provided a data storage computing device connected to a user computing device and storing search information, including a communication unit configured to exchange data with the user computing device, a storage unit configured to store the search information, and a control unit configured to perform a search using the search information, in which the control unit is configured to receive industrial product information about each of an industrial product and a comparative industrial product as a search keyword from the user computing device, perform a search for the search keyword, and provide a search result for the search keyword to the user computing device, and the search result provides a search item including at least one comparative industrial product corresponding to the search keyword.

The present disclosure provides a computer-readable recording medium in which a program capable of executing the control method of the present disclosure is recorded.

The additional scope of applicability of the present disclosure will become apparent from the following detailed description. However, since various changes and modifications within the spirit and scope of the present disclosure can be clearly understood by those skilled in the art to which the present disclosure pertains, it should be understood that specific embodiments described in the detailed description are given by way of example only should be understood.

### BRIEF DESCRIPTION OF THE DRAWINGS

Exemplary embodiments can be understood in more detail from the following description taken in conjunction with the accompanying drawings, in which:

FIG. 1 is a configuration diagram of computing devices according to an embodiment of the present disclosure;

FIG. 2 illustrates a flowchart according to an embodiment of the present disclosure; and

FIG. 3 to FIG. 20 are output screens illustrating search results of a user computing device according to an embodiment of the present disclosure.

### DETAILED DESCRIPTION OF EMBODIMENTS

Hereinafter, specific embodiments will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

In the figures, the dimensions of layers and regions are exaggerated for clarity of illustration. Like reference numerals refer to like elements throughout. It will also be understood that when a layer, a film, a region or a plate is referred to as being ‘on’ another one, it can be directly on the other one, or one or more intervening layers, films, regions or plates may also be present. Further, it will be understood that when a layer, a film, a region or a plate is referred to as being ‘under’ another one, it can be directly under the other one, and one or more intervening layers, films, regions or plates may also be present. In addition, it will also be understood that when a layer, a film, a region or a plate is referred to as being ‘between’ two layers, films, regions or plates, it can be the only layer, film, region or plate between the two layers, films, regions or plates, or one or more intervening layers, films, regions or plates may also be present.

Hereinafter, the embodiments disclosed in the present specification will be described in detail with reference to the accompanying drawings, but the same or similar components are assigned the same reference numerals regardless of reference numerals, and overlapping descriptions thereof will be omitted. The suffixes “module” and “unit” for the components used in the following description are given or mixed in consideration of only the ease of writing the specification, and do not have distinct meanings or roles by themselves. In addition, in describing the embodiments disclosed in the present specification, if it is determined that detailed descriptions of related known technologies may obscure the gist of the embodiments disclosed in the present specification, the detailed description thereof will be omitted. In addition, the accompanying drawings are only for easy understanding of the embodiments disclosed in this specification, and the technical idea disclosed herein is not limited by the accompanying drawings, and it should be understood to include all modifications, equivalents and substitutes included in the spirit and technical scope of the present invention.

Terms including an ordinal number, such as first, second, etc., may be used to describe various components, but the components are not limited by the terms. The above terms are used only for the purpose of distinguishing one component from another.

When a component is referred to as being “coupled” or “ connected” to another component, it may be directly coupled or connected to the other component, but it should be understood that another component may exist in between. On the other hand, when a component is referred to as being “directly coupled” or “directly connected” to another element, it should be understood that no other element exists in between.

The singular expression includes the plural expression unless the context clearly dictates otherwise.

In the present specification, it should be understood that terms such as “comprise” or “include” are intended to designate that a feature, number, step, operation, component, part, or combination thereof described in the specification exists, but does not preclude the possibility of the presence or addition of one or more other features or numbers, steps, operations, components, parts, or combinations thereof.

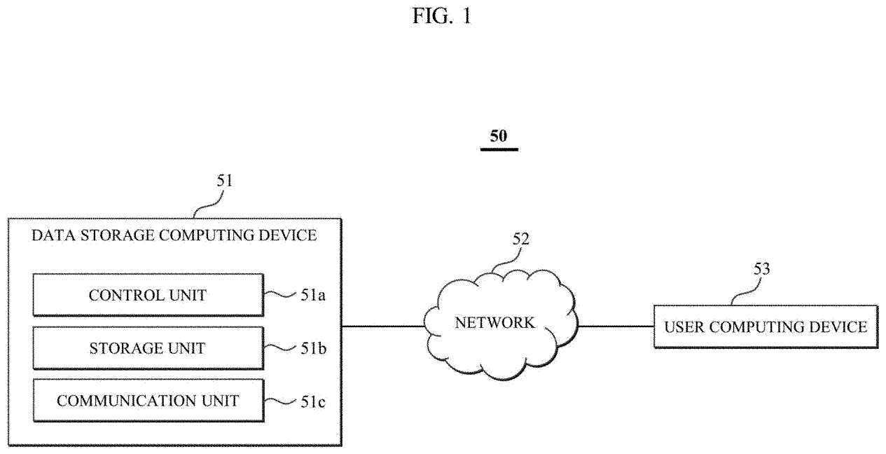

FIG. 1 illustrates an example of a configuration diagram 50 of a data storage computing device according to an embodiment of the present disclosure.

As illustrated in FIG. 1, a data storage computing device 51 according to the present disclosure may include a control unit 51a, a storage unit 51b, and a communication unit 51c. The communication unit may be connected to any user or purchaser or evaluator computing device 53 by any network 52 to transmit data.

The data storage computing device 51 may include more components than the illustrated components 51a to 51c, but those components are omitted to deliver the essential point. The user computing device 53 may further include an input unit for input and an output unit for displaying an output, in addition to the components 51a to 51c of the data storage computing device.

At least some of the respective components may operate in cooperation with each other in order to implement an operation, control, or control method of the user computing device or data storage computing device according to various embodiments described below. Further, the operation, control, or control method of the computing devices may be implemented in the computing device by driving at least one application program stored in the storage unit.

The data storage computing device is a combination of one or more computing devices and may be composed of at least one computing device or at least one server having any configuration, etc. The storage unit 51b stores search information for responding to a search request from the user computing device, and thus may derive a search result using the search information based on a search keyword input by the user and transmit the search result back to the user computing device. If the data storage computing device is a combination of a plurality of computing devices, these computing devices may be configured to be connected to each other by communication and configured to cooperate and help with each other. The data storage computing device may be implemented in various forms, such as a server-client model, a peer-to-peer (P2P), and a distributed computing system.

A control method for a keyword based search of the present disclosure is characterized in that it is a control method for the user computing device that is connected to the data storage computing device 51 including search information and performs a keyword based search may include receiving industrial product information about a predetermined industrial product as the search keyword (S71), requesting the data storage computing device to search with the search keyword (S72), and receiving a search result for the search request from the data storage computing device (S73). The search result includes a search item including at least one comparative industrial product corresponding to the search keyword, and the comparative industrial product is an industrial product corresponding to the predetermined industrial product in terms of at least one of a purpose of use or a main configuration. The industrial product information may include at least one of a name or a type, or a specific category of the industrial product.

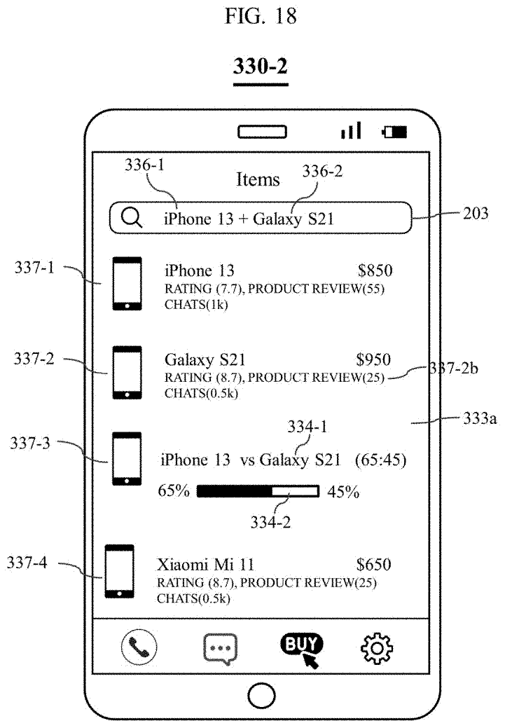

The search keyword according to another embodiment of the present disclosure may include industrial product information about at least one industrial product(s). For example, FIG. 18 illustrates a case in which industrial product information about two industrial products, that is, the name of the industrial product, is included as the search keyword. The comparative industrial product may be a name or a type or a category of another industrial product that can be compared with the industrial product.

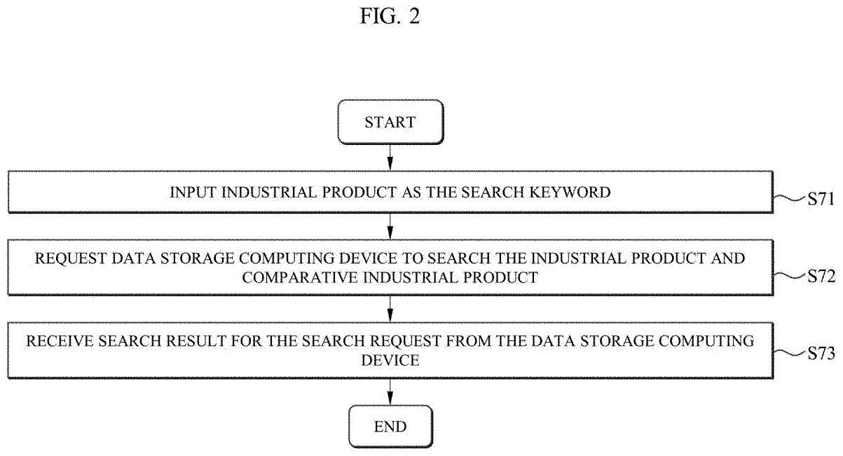

FIG. 2 illustrates a flowchart according to an embodiment of the present disclosure.

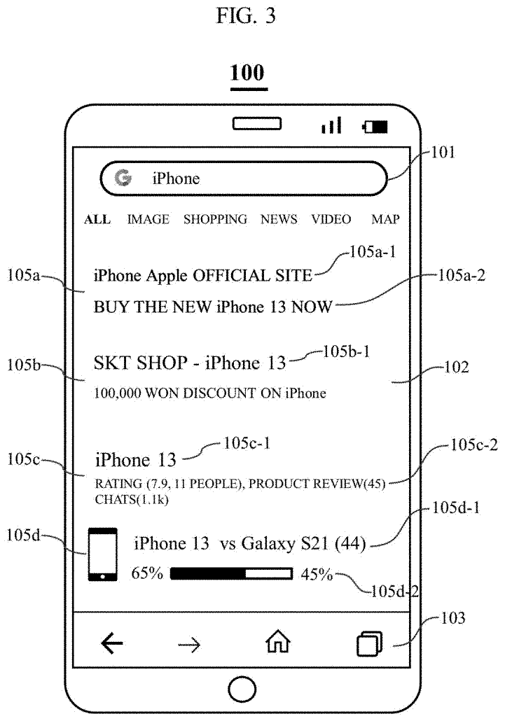

The above steps S71 to S73 will be briefly described with reference to FIGS. 3, 4, 17, and 18.

For step S71, in the data storage computing device 51 connected to a user computing device and including search information, the data storage computing device including the communication unit 51c that exchanges data with the user computing device, the storage unit 51b that stores the search information, and the control unit 51a that performs a search using the search information, the control unit receives industrial product information about a predetermined industrial product as the search keyword from the user computing device and provides a search result corresponding thereto. The search information may include information about a single item and a comparison item to be described later and detailed information included in these items in advance.

Then, in step S72, the control unit 51a searches for the predetermined industrial product and the comparative industrial product in response to the search request of the user computing device 53. The comparative industrial product according to an embodiment of the present disclosure may be an industrial product corresponding to the predetermined industrial product in terms of at least one of a purpose of use or a main configuration) for comparison with the predetermined industrial product. The control unit 51a of the data storage computing device 51 may derive a search result through a search for a predetermined industrial product and a comparative industrial product corresponding to a transmitted search keyword, using the search information stored in the storage unit 51b, in response to reception of the transmitted search keyword.

That is, the data storage computing device 51 performs a search for the search keyword received from the user computing device 53. The search result may provide a search item including at least one of the comparative industrial products corresponding to the search keyword. Specific details of performing the search have already been disclosed in many technical documents, and thus are omitted for the sake of brevity of the present disclosure.

In step S73, the control unit 51a provides the search result for the search keyword to the user computing device 53.

The search result includes the search item including at least one of the comparative industrial products corresponding to the search keyword. The user computing device 53 receives the search result obtained by the requesting step and displays the search result on a corresponding screen. In the present disclosure, the search result is characterized in that it is derived by reflecting at least one of the single information or the comparative information.

In the requesting step S72, the user computing device 53 may request the data storage computing device 51 to perform a search for the predetermined industrial product and the comparative industrial product together in response to the search keyword.

The present disclosure is characterized in that it is a data storage computing device connected to a user computing device and including search information, the data storage computing device including a communication unit that exchanges data with the user computing device, a storage unit that stores the search information, and a control unit that performs a search using the search information, in which the control unit receives industrial product information about a predetermined industrial product as a search keyword from the user computing device, performs a search for the predetermined industrial product and a comparative industrial product of the predetermined industrial product, and provides a search result for the search keyword to the user computing device, and the search result includes a search item including at least one of the comparative industrial products corresponding to the search keyword, and the comparative industrial product is an industrial product corresponding to the predetermined industrial product in terms of at least one of a purpose of use or a main configuration.

The above steps S71 to S73 will be described in detail with reference to FIGS. 3 to 20.

FIG. 3 illustrates an output screen 100 that receives a keyword search input from the user computing device 53 and displays the search result according to an embodiment of the present disclosure.

The output screen of this example consists of a search window 101, a result window 102, and a menu window 103. The user computing device 53 may request the data storage computing device 51 to search for the search keyword input through the search window 101, receive the search result from the data storage computing device 51, and display the search result as a plurality of search items in the result window 102.

In the above example, the search result for the keyword search is displayed as a plurality of search items, such as in a Naver search or a Google search. In the output screen 100, four search items 105a to 105d as the search result are displayed on the result window 102 when ‘iPhone’, which is the name of a predetermined industrial product, is input as a search keyword in the search window 101. These search items may be to display the search result received from the data storage computing device 51 on an output device of the user computing device 53.

As in the above example, in the present disclosure, the industrial product or the comparative industrial product may mean a name or a product name or type, a specific category, etc., which are information thereof, in an ambiguous sense. That is, the search keyword may be at least one of the name or the type or the specific category of the industrial product. The above example illustrates a case in which ‘iPhone’ is input as the industrial product or the name of the industrial product. In addition, the comparative industrial product may specifically include the industrial product name or product name or type or specific category as a search result corresponding to the search keyword.

In the present disclosure, the search item may be one in which a search result based on the search keyword is divided into a plurality of items and displayed. In the above example, the search result is divided into four search items 105a to 105d and displayed in the user computing device, and the search items may respectively include at least one of item names 105a-1 to 105d-1 and at least one of item descriptions 105a-2 and 105d-2. The item name may be a title including a name or type or a specific category of an industrial product, etc. for the search result, and the item description may be brief information or a description of the item. In addition, when the item is selected, detailed information about the selected item may be generally provided. In the present disclosure, the search item may be simply referred to as an item.

In this example, both the item name and the item description are provided. The first and second search items 105a and 105b among the search items indicate general existing search items.

However, the third and fourth search items 105c and 105d include the industrial product or comparative industrial product as the search result. The search items 105c and 105d include the name of the industrial product or comparative industrial product in the item names 105c-1 and 105d-1, respectively, and may be the single item 105c or the comparison item 105d. The item descriptions 105c-2 and 105d-2 may include at least one of the single information 105c-2 and the comparative information 105d-2.

The third search item 105c in this example includes ‘iPhone 13’, which is the name of the industrial product, in the item name 105c-1, and the item description 105c-2 includes ‘rating (7.9, 11 people), product review (45), and Chats (1.1k)’. The ‘Chats (1.1k)’ may mean that the number of messages, reviews, or comments, etc. registered by other users is 1.1k (1,100). In the fourth search item 105d, ‘iPhone 13’ and ‘Galaxy S21’, which are two industrial products to be compared are included in the item name 105d-1, and in the item description 105d-2, their comparative preferences are displayed as a visual bar chart.

The control unit of the present disclosure is characterized in that it includes a comparative preference displayed in the form of a visual diagram or chart in the search item and the comparative preference is evaluation information for comparing the preference of the predetermined industrial product with at least one of the comparative industrial products or a plurality of the comparative industrial products.

The comparative preference refers to information about which one of a plurality of industrial products to be compared is preferred. The products to be compared may be an industrial product and at least one of comparative industrial products or a plurality of comparative industrial products.

The control unit of the present disclosure is characterized in that it includes single information or comparative information in the search item, the single information includes evaluation information about a single industrial product without a comparison target or a single comparative industrial product, and the comparative information includes evaluation information for comparing the predetermined industrial product with at least one of the comparative industrial products or a plurality of the comparative industrial products.

In an embodiment of the present disclosure, the single information may include at least one of specification information, single preference, product review, or a meeting room, the comparative information may include at least one of specification comparison, comparative preference, comparative review, and meeting room.

In an embodiment of the present disclosure, the single information and comparative information may include evaluation information for a single industrial product or a plurality of industrial products. In the case of the single information, the evaluation information may be at least one of specification information, single preference, product review, or meeting room, and in the case of the comparative information, the evaluation information may be at least one of specification comparison, comparative preference, comparative review, or meeting room.

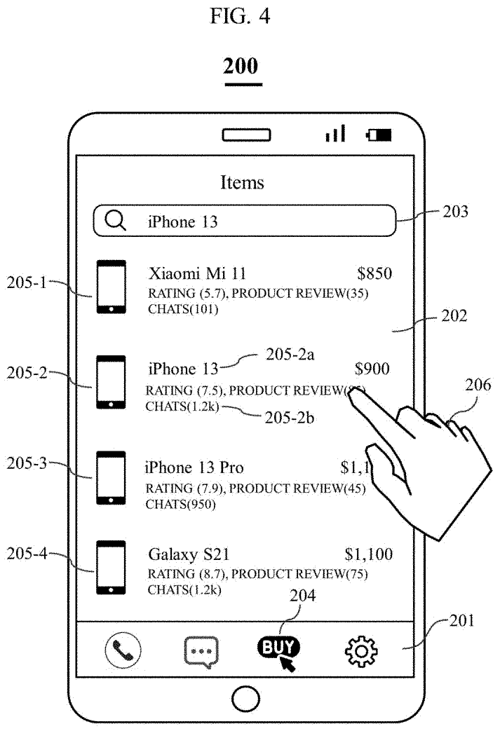

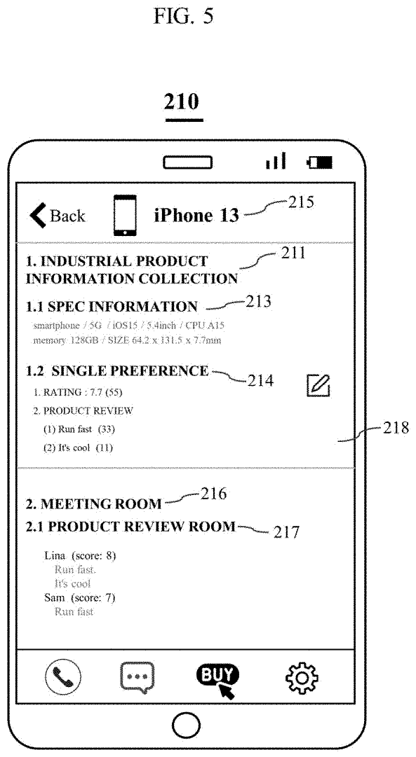

When one of search items that are the search result is selected by the user, detailed information about the selected search item may be provided to the user. In addition, the single information or comparative information may not only be an item description of the search item as illustrated in FIG. 3 or 4, but may also mean detailed information displayed when the search item is selected as illustrated in FIGS. 5 to 6 and 19 to 20. Accordingly, the single information and the comparative information may further include the detailed information.

Items of the search result can be classified as a single item for a single industrial product or a comparison item including comparative information for a plurality of industrial products. Therefore, the single item may include one industrial product in the item name or item description, and the comparison item may include a plurality of industrial products in the item name or item description.

These search items 105c and 105d may include a single preference 105c-2 or a comparative preference 105d-2 as single information or comparative information of the corresponding industrial product. The single preference may be preference information for a single industrial product, such as a rating, a product review, etc. for one industrial product. The comparative preference may be at least one of preference information or comparative review for comparing a plurality of industrial products to be compared. This preference information may be provided in the form of a satisfaction, percentage or preference chart (or may mean a chart), etc.

In this example, the single preference 105c-2 indicates ‘rating (7.5, 11 people), product review (45), and Chats (1.1k)’. That is, the single preference 105c-2 may include at least one of a rating, a product review, or a meeting room (may mean ‘chats (1.1k)’ in the example above) for one industrial product or one comparative industrial product as illustrated in FIG. 3. The meeting room refers to ‘1.1k’, which is simple information of the meeting room.

In this example, the comparative preference 105d-2 includes only the preference chart. However, the comparative preference according to an embodiment of the present disclosure may include at least one of a preference chart, a comparative review, or a meeting room for a plurality of industrial products. The example 105d-2 includes the preference chart 105d-2 displayed as a comparative preference between ‘iPhone 13’ and ‘Galaxy S21’. That is, the preference chart that compares and shows the preference of two industrial products may be displayed in the form of a score, a percentage, a visual diagram or a chart, etc. Such a rating, single preference, comparative review, comparative preference, or meeting room may further include the numbers 105c-2 and 105d-1 of participants who participated in the preference evaluation or users who made input.

The control unit 51a of the present disclosure is characterized in that it controls the comparative industrial product to include a higher category or higher type of the industrial product.

In the present disclosure, the industrial product information input or transmitted as the search keyword may be ‘Galaxy S21’ or ‘iPhone 13’, etc., which are direct named or product named of the industrial product, may be ‘Galaxy’ or ‘iPhone’ indicating the type of industrial product, and the specific category may be ‘Smartphone’, Galaxy, iPhone, etc. To this end, the search information of the storage unit 51c of the data storage computing device 51 may already include the type and category of the industrial product.

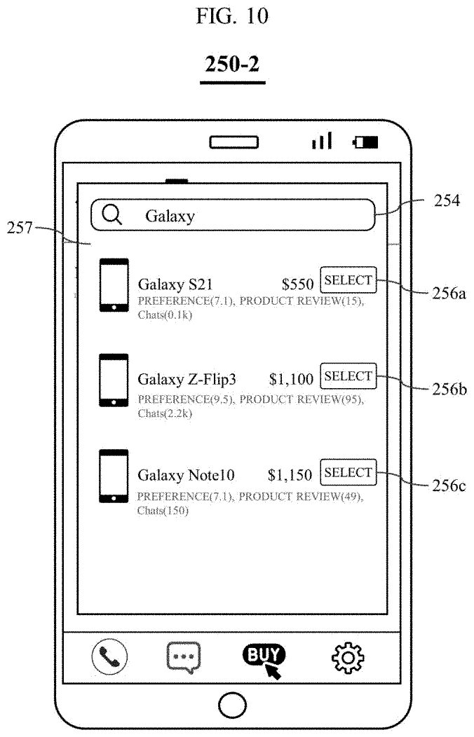

In the example of FIG. 3, ‘iPhone’, which is a type or category of an industrial product, is input as the search keyword. The comparative industrial product refers to an industrial product corresponding to the input industrial product in terms of at least one of a purpose of use or a main configuration for comparison with the industrial product input as a search keyword, and may mean a comparison target for the industrial product input as the keyword. In this example, the comparison target may be the industrial product and the comparative industrial product. This comparative industrial product may be designated and input by a user as illustrated in FIG. 10 or may be automatically included in a search result, that is, a search item by searching for the industrial product as illustrated in FIGS. 4, 17 and 18.

In the present disclosure, when ‘iPhone’ is input as the search keyword, the search item of the search result may include at least one of comparative industrial products such as ‘Galaxy Phone’ or ‘Xiaomi Mi’, which is a type of industrial product corresponding to the ‘iPhone’. As another example, if ‘smartphone’, which is a type or category, is designated as the search keyword, the comparative industrial product may include tablet PCs such as ‘iPad’ or ‘Apple Watch’, smart watch, etc.

Therefore, the comparative industrial product may be included in the higher category of the industrial product input or transmitted as the search keyword. For example, when ‘smartphone’ is designated as the search keyword, ‘iPhone’ and ‘Galaxy Phone’ may not be the comparative industrial products. This is because the iPhone, the Galaxy phone, etc. may be included in the type or category of the ‘smart phone’.

As described above, the comparative industrial product of the present invention may mean at least one of a comparative industrial product an industrial product corresponding to the industrial product input or transmitted as the search keyword in terms of at least one of a purpose of use or a main configuration, or an industrial product included in a higher category. For example, if ‘iPhone 13’ is input or transmitted as the search keyword, ‘Galaxy Phone’ such as ‘Galaxy S21 and ‘Xiaomi Phone’ such as ‘Xiaomi Mi 11’ can be provided as a single item and comparison item in the search results, as the comparative industrial product for ‘iPhone’, which is the higher category of ‘iPhone 13’. In addition, ‘iPhone 12’ can be provided as a comparison target. In this case, comparative information about ‘iPhone 13 vs. iPhone 12’ can be provided. As such, the object of the present disclosure is not only to provide the comparative industrial product that is not directly related to the search keyword as the single item and comparison item as the search result, but also to provide comparative information about the comparative industrial corresponding to the predetermined industrial product in terms of at least one of a purpose of use or a main configuration.

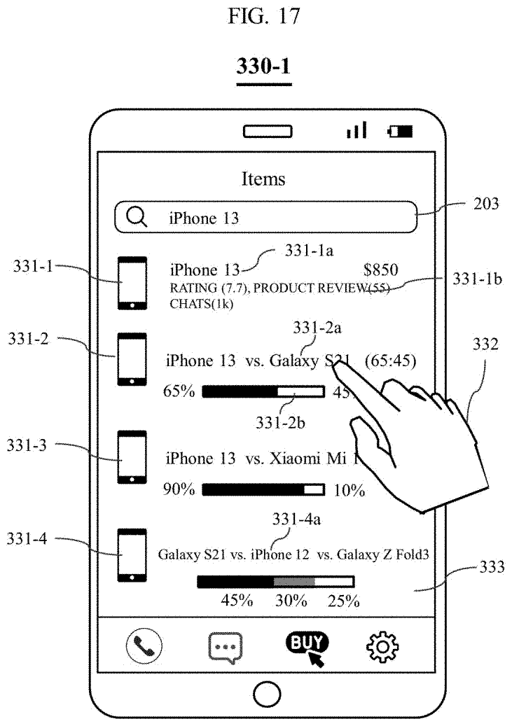

In the present disclosure, the search item is characterized in that it provides comparative information about the predetermined industrial product and the comparative industrial product or a plurality of the comparative industrial products. Examples of this are the search item 105d of FIG. 3, the search items 331-2 to 331-4 of FIG. 17, and the search item 337-3 of FIG. 18.

Here, the category or type may be a criterion for classifying like or similar industrial products. For example, the category of ‘iPhone 13’ may include iPhone-based smartphones such as ‘iPhone 13 mini’, ‘iPhone 13 Pro’, and iPhone 12’, and in the ‘smartphone’ category, which is the higher category of the ‘iPhone 13’ category, may include Galaxy phones, Xiaomi phones, etc. that have the same, similar, or corresponding purpose of use or main configuration may be included. The type or specific category may be stored in at least one of the user storage computing device or data storage computing device 51, but in general it may be desirable to be stored in the storage unit of the data storage computing device 51.

FIG. 4 illustrates another screen 200 for outputting the search result as a plurality of search items through a keyword search in the user computing device 53 according to an embodiment of the present disclosure.

This example is an output screen when a purchase icon 204 is selected in a menu window 201. That is, the user may select the search item and proceed with the purchase. As in the above example, the output screen of the user computing device may include the menu window 201, a result window 202, and a search window 203, and may include a search result for ‘search keyword’ input through the search window 203 in the result window 202.

In the above example, when ‘iPhone 13’ (also called ‘iPhone 13’,) which is the name of an industrial product, is input as the search keyword in the search window 203 of the user computing device 53 and transmitted to the data storage computing device 51, the data storage computing device 51 may perform a search for not only the predetermined industrial product, but also the comparative industrial product that has the same as, similar to or corresponding to at least one of purpose of use or a main function with the search keyword, for comparison with the predetermined industrial product, and display the search result as a search item. The user computing device 53 receives the displayed search result and displays four search items 205-1 to 205-4 as the search result in the result window 202, on the screen. In this example, each of the four search items 205-1 to 205-4 includes one industrial product, that is, a single item as the item name. As described above, industrial product information about a predetermined industrial product is provided as the search keyword of the present disclosure, and the industrial product information may be a name or product name or type of an industrial product.

The search result may include a search item for a predetermined industrial product corresponding to the keyword, a search item(s) for a comparative industrial product, and a search item composed of a combination thereof, and the search item(s) for the comparative industrial product may be slightly different from a company, option, function, or purpose of use released depending on a predetermined industrial product, which is a search keyword.

The example of FIG. 4 displays four single items as the search result. Item names 205-2a of these items are ‘Xiaomi Mi 11’ 205-1, ‘iPhone 13’ 205-2, ‘iPhone 13 Pro’ 205-3, ‘Galaxy S21’ 205-4, and an item description 205-2b includes a rating, product review, and Chat (which may mean a meeting room).

As such, a major feature of the present invention is that when ‘iPhone 13’ is transmitted as a search keyword, ‘Xiaomi Mi 11’ 205-1 and ‘Galaxy S21’ 205-4, which are not directly related to the search keyword, can be included as the search items. This search result is a unique feature provided because it includes a step of searching for the comparative industrial product when search is performed in the present disclosure. In other words, an object of the present disclosure is to provide single information or comparative information about the comparative industrial product that is not directly related to the search keyword by including the step of searching for the comparative industrial product corresponding to the search keyword.

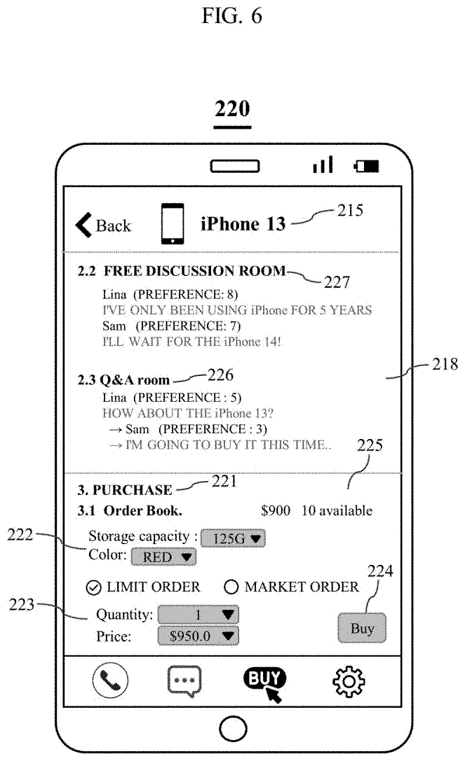

FIGS. 5 and 6 are output screens 210 and 220 when ‘iPhone 13’ is selected from among the search items which are the search result of the user computing device 53 according to an embodiment of the present disclosure.

The above example illustrates the screens 210 and 220 of detailed information of ‘iPhone 13’ 215 displayed when ‘iPhone 13’ 205-2 is selected from among the search items in the user computing device of FIG. 4. That is, in this example, one industrial product name is included in the item name, and thus this example is a detailed screen of single information. On the output screens 210 and 220 of the detailed information, ‘iPhone 13’, which is the selected industrial product, may be displayed in a title window 215. The data storage computing device 51 may provide a corresponding search result (single information including detailed information about the selected industrial product, etc.) to the user computing device 53 in response to the selection of the search item 205-2 of the user computing device 53, and the user computing device 53 may output the received information to the screen.

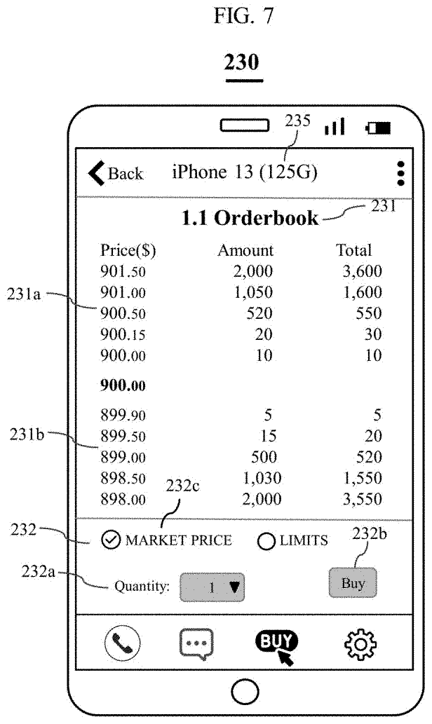

Detailed information of FIGS. 5 and 6 may include at least one of an industrial product information collection 211, a meeting room 216, and a purchase 221. The industrial product information collection 211 may include at least one of specification information 213 and preference 214. In the illustrated example, the detailed information may include all of the industrial product information collection 211, the meeting room 216, and the purchase 221. Further, when the user selects a corresponding title among the industrial product information collection 211, the meeting room 216, and the purchase 221211, 216, and 221, more detailed information corresponding to the selected title may be provided. That is, when the titles 211, 213, 214, 217, 227, 226, and 225 included in the detailed information are selected, as illustrated in FIGS. 7 to 9, it may be output to include more detailed information. The search items provided as the search result include single information or comparative information, and the single information and the comparative information may further include the detailed information, the detailed information may include a title, and the title may include further more detailed information.

The industrial product information collection 211 may include specification information 213 for a single industrial product 215, or evaluation information such as a single preference 214 including a rating and product review. The single preference 214 of the present disclosure may include the rating and product review as evaluation information for the ‘iPhone 13’ 215, which is a single industrial product. The meeting room 216 may include at least one of a product review room 217, a free discussion room 227, and a Q&A room 226. In addition, the purchase 221 may include an order book 225, an order option 222, a purchase order 223, and a purchase button 224, as illustrated in the example. The user computing device 53 may receive selections corresponding to the order option and the purchase order and purchase the industrial product through the purchase button 224. In the example above, as the order option for ‘iPhone 13’ 215, the memory size (storage) of ‘125G’ and the color ‘red’ are selected, and for the purchase order 223, a limit order is selected, ‘1’ as the quantity and ‘$950.0’ as the price are selected. When the order option 222 is changed, it may be automatically switched to and displayed on a corresponding order book 225 related screen (to be described later in FIG. 7).

FIG. 7 illustrates an example of an output screen 230 illustrating order book information 231 for purchase of the industrial product in the user computing device according to an embodiment of the present disclosure.

The above example is the output screen 230 displayed on the user computing device 53 when the user selects the order book 225 in FIG. 6. The output screen 230 may include an industrial product name 235, order book information 231, and a purchase order 232. In this example, the industrial product name for purchase is ‘iPhone 13 (125G)’ 235, and the order book information 231 for this includes both a selling list 231a and a buying list 231b. In the above example, since the purchase order 232 is a market order 232c, when only a quantity 232a is selected and a purchase button 232b is selected, the purchase is concluded. In this example, 1 is selected as the quantity, and the price is the market order, and thus the sale can be immediately matched to the lowest $900.00 in the selling list 231a.

The order book information 231 according to an embodiment of the present disclosure is a book for recording orders of all sellers (sellers) and purchasers (buyers) as a quote window in which the prices and quantities desired by sellers and users are generally registered in advance. The purchase order or sale order for the industrial product includes a limit order in which both quantity and price are provided, and a market order in which only quantity is provided and a transaction is concluded immediately at a market price. If the price and quantity match in the order book information, matching is made for the corresponding industrial product, and a designated sale is concluded. In one embodiment of the present disclosure, when the matching is made, a step of processing a payment for purchasing the industrial product in the matched user computing device may be included.

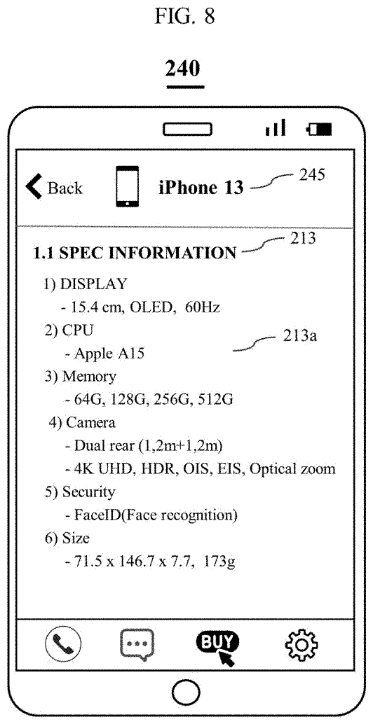

FIG. 8 illustrates an output screen 240 illustrating specification information 213 for the industrial product in the user computing device 53 according to an embodiment of the present disclosure.

The above example is the output screen 240 displayed when the specification information 213 is selected on the output screen 210 of FIG. 5. The specification information 213 may include specific and detailed specification information 213a for a selected industrial product 245. In addition, a title window 245 displays ‘iPhone 13’ 245, which is the name of the industrial product selected by the user in FIG. 5.

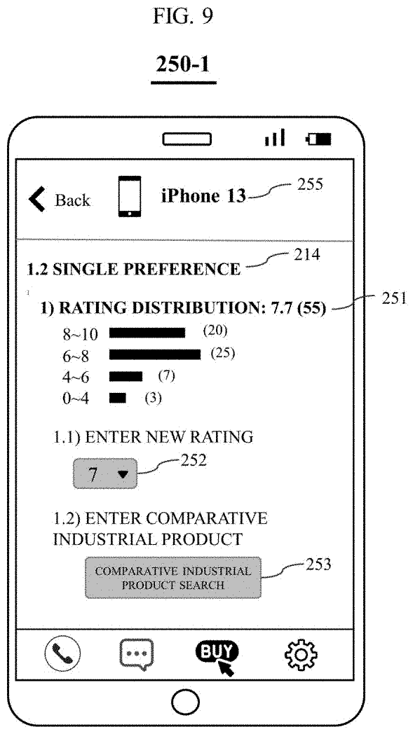

FIG. 9 illustrates an output screen 250-1 for the single preference 214 according to an embodiment of the present disclosure.

This example illustrates a detailed single preference 251 when selecting the single preference 214 in FIG. 5. The example visually illustrates the rating, which is the single preference of an industrial product 255, in the form of a number of graphs 251 that are diagrams. In this example, the total number of people who provided the above rating is a total of 55 people 251. In addition, this example may include a rating input button 252 for the user to input a new rating for the industrial product 255. With the button 252, a new rating can be selected or an already selected rating can be canceled.

In addition, the present disclosure may include a comparative industrial product input button 253 for receiving a comparative industrial product as an input. That is, the button 253 for searching for a comparison industrial product with respect to the already input industrial product 214 and receiving a new comparison industrial product is provided. When this button 253 is selected, the output screen 250-1 moves to a screen 250-2 for searching and inputting the comparative industrial product of FIG. 10.

FIG. 10 illustrates an output screen 250-2 for inputting the comparative industrial product according to an embodiment of the present disclosure.

When the comparative industrial product input button 253 is selected by the user in the example of FIG. 9, the user computing device 53 may further output a pop-up window 257 for the user to input the comparative industrial product as illustrated in FIG. 10. When a search keyword (‘Galaxy’ in the example illustrated) for searching for the comparative industrial product is input through a search window 254 of the pop-up window 257, the search result based on the search keyword is output in the pop-up window 257. As in the example, when there are a plurality of search results, the user computing device 53 may receive input by at least one of the selection buttons 256a to 256c of respective result items, and designate the product indicated in the result item as a comparative industrial product and transmit it. In other words, in the present disclosure, at least one of comparative industrial products can be designated through the selection buttons 256a to 256c, as illustrated in FIG. 10.

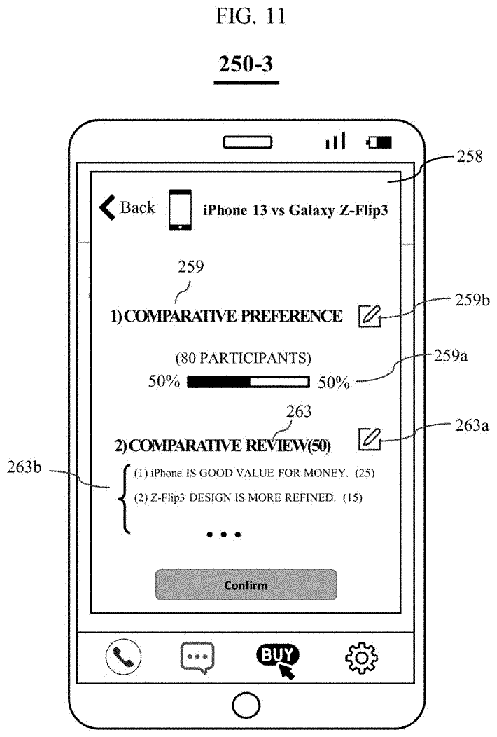

FIG. 11 illustrates a case in which only one ‘Galaxy Z-Filp3’ 256b is selected as the comparative industrial product. However, the present disclosure is not limited to this case, and a plurality of items (e.g., ‘Galaxy Z-Filp3’ 256b and ‘Galaxy S21’ 256a) may be selected and input together. As in the example, when two comparative industrial products are selected together, three industrial products 255, 256a, and 256b become the comparison targets, and comparative information for the industrial products 255, 256a, and 256b can be provided and displayed. In other words, the input industrial product is ‘iPhone 13’, and ‘Galaxy Z-Filp3’ and ‘Galaxy S21’ are input as the comparative industrial products, and thus there are a total of three industrial products to be compared.

The present invention may provide not only a method of including a comparative industrial product in a search result even when the comparative industrial product is not provided in the search keyword, but also comparative information about the predetermined industrial product and the comparative industrial product when the industrial products are provided as the search keyword. In addition to this, even when two or more comparison targets are included in the search keyword, a comparative industrial product other than the comparison targets may be included in the search results.

An object of the present disclosure is to provide comparative information about industrial products including the comparison targets, such as an industrial product and a comparative industrial product, or a plurality of comparative industrial products. Alternatively, an object thereof is to provide a comparative industrial product not directly related to a predetermined industrial product is provided as a search result through a search keyword, and include single information or comparative information in the search result. In the present disclosure, the comparative preference may include at least one of the preference chart, the comparative review, or the meeting room for a plurality of industrial products to be compared. The comparative preference refers to information about which of the industrial products to be compared is preferred.

As described above, the comparative industrial product may be another industrial product having the same, similar, or corresponding main configuration or purpose of use for comparison with the predetermined industrial product, and may be another industrial product to be compared. In the above example, a configuration for newly inputting the name of the comparative industrial product may be provided. In the example of FIG. 9, the comparative industrial product input button 253 for receiving the name of the comparative industrial product as an input may be provided to provide at least one of the comparative preference or the comparative review between the industrial product and the comparative industrial product, that is, comparison targets.

However, unlike the configuration in which the name of this comparative industrial product is input, the present disclosure can be configured to provide at least one of ‘iPhone 13’ 331-1 or comparative industrial products 331-2 to 331-4 of ‘iPhone 13’ as a search result, in response to ‘iPhone 13’, which is a search keyword for a predetermined industrial product, as shown in FIG. 17. This has already been described in FIGS. 3 and 4.

In other words, even without the comparative industrial product input button 253, a search can also be performed for the comparative industrial product only by a keyword search for the industrial product. That is, the example of FIG. 17 may include a comparison item for the comparative industrial product to be compared as a search result for one input industrial product information (e.g., industrial product name). Alternatively, as in the example of FIG. 4, for the search for ‘iPhone 13’ 203, ‘Xiaomi Mi 11’, which is a comparative industrial product, may be included as a single item. As another example, FIG. 18 illustrates a case in which each of the industrial product names for the predetermined industrial product and comparative industrial product is included as a search keyword. In the example of FIG. 18, ‘Xiaomi Mi 11’, which is not directly related to the industrial product names 336-1 and 336-2 input as the search keyword, may be included in a search item 337-4 of the search result as the comparative industrial product.

The present disclosure is characterized in that it includes a step of receiving at least one of the comparative information or the single information.

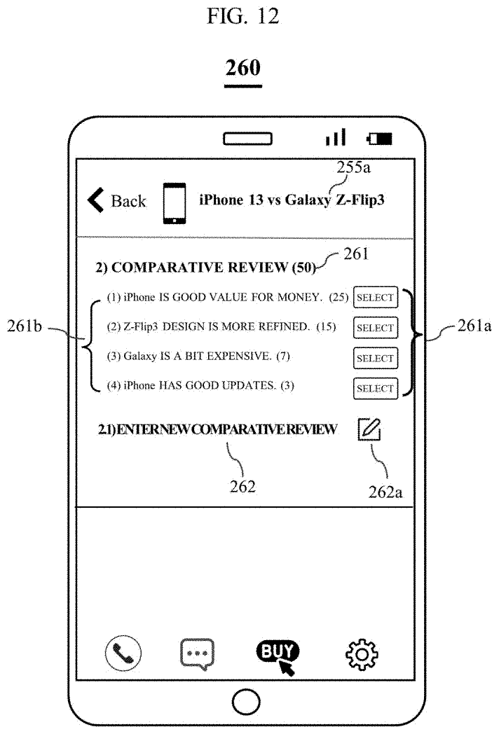

FIGS. 11 to 12 illustrate examples of output screens 250-3 and 260 for displaying and receiving comparative information in the user computing device according to the present disclosure.

FIG. 11 illustrates an example of the output screen 250-3 capable of inputting the comparative preference and the comparative review according to an embodiment of the present disclosure.

This example is a screen for the comparative preference and comparative review when ‘Galaxy Z-Flip3’ (256b) is input as the comparative industrial product in FIG. 10. As illustrated FIG. 11, the present disclosure may display a pop-up window 258 for newly inputting a preference chart including the comparative preference, which is comparative information, and the comparative review. The illustrated pop-up window 258 may display at least one of a preference chart 259 and a comparative review 263.

As described above, the comparative preference is information about which industrial product is more preferred among the predetermined industrial product (‘iPhone 13’ in the example illustrated) and at least one comparative industrial product(s) or a plurality of comparative industrial products. The comparative preference is evaluation information about industrial products to be compared, and may include percentages or scores, various visual charts, charts or comparative reviews, or chat rooms. Further, the comparative review or chat room may mean a comment including evaluation information about at least one of industrial products or at least one comparative industrial products. The comparative preference of the present disclosure may include at least one of the preference chart, the comparative review, or the meeting room for the plurality of industrial products.

For the comparative preference 259 in this example, a preference chart 259a for two industrial products to be compared is displayed in the form of a visual bar graph. In addition, a button 259b that allows the user to input a new comparative preference is included. As method of inputting the comparative preference, various methods such as a method in which the user inputs the ratings of the corresponding industrial product and comparative industrial product, respectively, as illustrated in FIG. 9, or a method of selecting at least one preferred from the corresponding industrial product and the comparative industrial product may be included. As another example, the comparative preference may be input by dividing those having high preference and low preference among a plurality of industrial products (meaning the industrial product and the comparative industrial product, or a plurality of comparative industrial products) to be compared into two or more levels. For example, the user may input a comparative preference such as 10 points for the first level preference, 5 points for the second level preference, and 2.5 points for the third level preference. In addition to these examples, various methods for inputting the comparative preferences may be provided by other methods.

Although the preference chart 259a in this example contains a bar graph for comparing two industrial products, in contrast, the preference chart 259a may be displayed as a plurality of bar charts 251 as illustrated in FIG. 9 or a pie chart divided into a plurality of zones or a bar chart 331-4 divided into a plurality of zones in FIG. 17, etc. so that three or more industrial products can be compared. The comparative preference in the form of the bar chart (or mean chart) and the pie chart may be displayed based on a specific criterion, for example, 100%, or 10 points, etc., and the comparative preference for a plurality of industrial products to be compared may be provided in the form of a percentage or score or satisfaction, etc.

As such, the comparative preference of the present disclosure may be provided in various forms capable of indicating preference among a plurality of industrial products to be compared. As in the example, the chart may include a bar graph, a pie graph, etc., and a method such as inputting a rating or designating and inputting the industrial product by an evaluator may be included.

The comparative review 263 in this example may include a comparative review 263b previously written for at least two industrial products (an industrial product and at least one comparative industrial product, or a plurality of comparative industrial products) to be compared, a button 263a for the user to input a new comparative review, etc. The comparative review according to an embodiment of the present disclosure may include evaluation information of users or evaluators about advantages and disadvantages of at least two industrial products to be compared.

The control method according to an embodiment of the present disclosure may further include receiving a new input of at least one of a product review and a comparative review for the industrial product from the user computing device 53, or receiving at least one of product review and comparative review that have already been input, and displaying the product reviews or the comparative reviews input through the receiving of the new input by applying the product reviews or the comparative reviews to the total number thereof. A detailed description thereof will be made with reference to FIG. 12 below.

The present disclosure is characterized in that it provides a control method for the user computing device that displays a plurality of evaluation text for a predetermined industrial product and the number of consents for the evaluation text, the method including displaying the number of consents to the evaluation text and a selection button for selecting with an indication of consent to the evaluation articles and reflecting the number of consents of the selected evaluation text and displaying the evaluation text again when the evaluation text is selected with the selection button, in which the evaluation text is a product review or comparative review for a search item selected from search items that are a search result corresponding to a search keyword for the predetermined industrial product, and the comparative review is an evaluation text with a plurality of industrial products as a comparison target, and the product review is an evaluation text for a single industrial product or a comparative industrial product. This will be described in detail with reference to FIG. 12.

FIG. 12 illustrates an output screen 260 of the user computing device for inputting a new comparative review according to an embodiment of the present disclosure. The example is a screen output when the comparison input button 263a is selected in FIG. 11.

The title window of FIG. 12 illustrates a name 255a of both the industrial product to be compared and the comparative industrial product in the comparative review. Accordingly, the comparative review may provide an evaluation or preference for a specified comparison target.

FIG. 12 includes, as the methods of inputting the comparative review, both a method 261a of selecting an existing comparative review 261b that has already been input in the user computing device 53 and a method of inputting a new comparative review 262. At least one selected comparative review may be transmitted to the data storage computing device through the selection button 261a by which at least one of the existing comparative reviews 261b is selected from the user computing device 53. Further, the user computing device 53 may provide a new comparative review through a button 262a for transmitting the new comparative review 262 other than the existing comparative review 261b to the data storage computing device 51.

In the above example, there are a total of four comparative reviews 261b previously input, and the user may select at least one of the selection buttons 261a of the comparative reviews 261b to provide or transmit the existing comparative review. If the selection button 261a is selected, the number of consents next to the corresponding comparative review may be recalculated and displayed. For example, when the user selects ‘iPhone is good value for money. (25)’, the number of consent may be changed to ‘(26)’ and displayed as “iPhone is good value for money. (26)”. Of course, since a new comparative review is added, the ‘comparative review (50)’ on the screen may be changed to a ‘comparative review (51)’.

That is, if the user wants to input a new comparative review other than the existing comparative review 261b, the user may select the input button 262a to input a new comparative review. The newly input comparative review may be newly included in the existing comparative review 261b and displayed. For example, if the user inputs “I like the folding Galaxy because it is small’ as a new comparative review on the user computing device, a total of five comparative reviews may be displayed on the screen by newly including ‘(5) I like the folding Galaxy because it is small (1)’, under the four existing comparative reviews 261b, and ‘(1)’ is the number of consents. In this case, the selection button 261a may be newly added next to ‘(5) I like the folding Galaxy because it is small (1)’ which is the new comparative review.

In addition, it is possible to provide a meeting room for exchanging messages about the industrial products to be compared in the user computing device 53.

In the present disclosure, the meeting room may include at least one of a ‘Q&A room’ in which questions and answers are transmitted, or a ‘comparative review room’ in which evaluation text on the industrial products is displayed.

The meeting room may be implemented with an instant messenger or network service (SNS) executed on the user computing devices 53. For example, a plurality of users may transmit messages through the meeting room provided by the instant messenger, etc. The instant messenger is a program capable of exchanging messages with a counterpart, such as WeChat, KakaoTalk, Line, or Telegram. That is, the instant messenger and SNS may be client programs that allow two or more users to exchange text, pictures, or videos using a network such as the Internet.

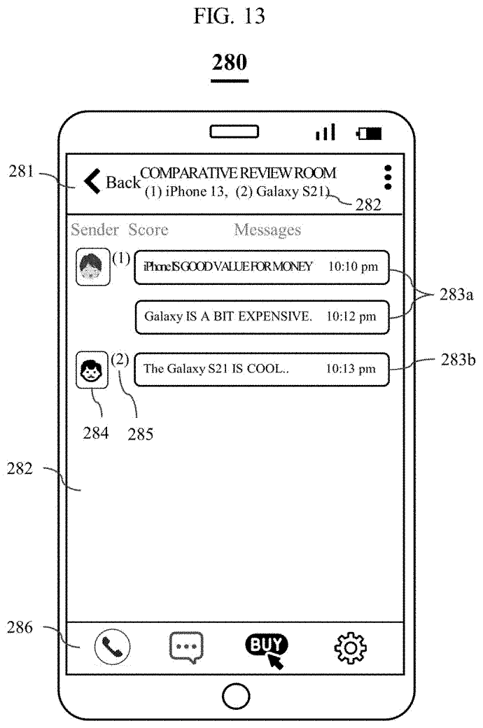

In the present disclosure, the meeting room may be provided through an instant messenger, etc. as illustrated in FIGS. 13 to 16.

FIGS. 13 to 16 illustrate examples of output screens 280 to 320 of a meeting room that provides a product review room and a Q&A room according to an embodiment of the present disclosure.

The present disclosure is characterized in that it includes providing a meeting room for comparing a predetermined industrial product and at least one of comparative industrial products having the same as or similar to at least one of purpose of use or a main function with the predetermined industrial product, or corresponding to the predetermined industrial product as comparison targets, receiving at least one of a comparative preference or a comparative review for the industrial product in the meeting room; and displaying at least one of the received comparative preference and the comparative review.

The control method according to an embodiment of the present disclosure may further include outputting messages exchanged with other participants when the meeting room is provided. In this case, the message exchanged may be a message for exchanging information about the subject of the industrial product and the comparative industrial product.

The meeting room of the present disclosure is characterized in that it includes a message window for outputting the messages of the participants of the meeting room in the form of speech bubbles, and in the speech bubble of the participants, the preference input by the participant is displayed together.

FIG. 13 illustrates an example of the output screen 280 of the comparative review room in the meeting room according to an embodiment of the present disclosure.

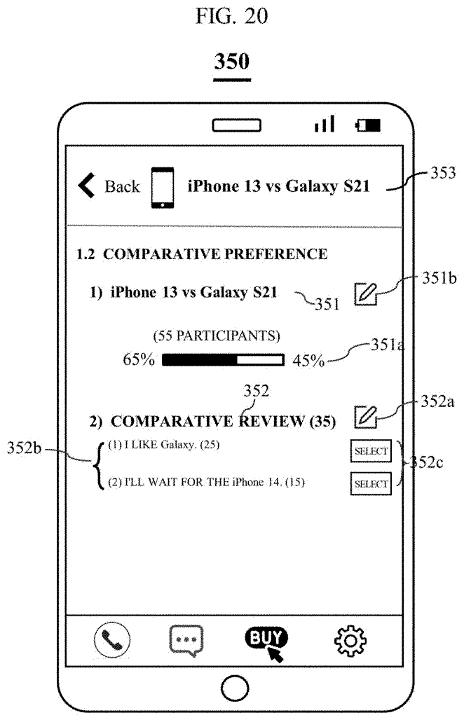

In the above example, the comparative review room is largely classified into a title window 281, a message window 282, and a menu window 286. In the title window 281, an industrial product and a comparative industrial product to be compared in the comparative review are displayed as ‘(1) iPhone 13, (2) Galaxy S21’ 282. As illustrated in FIG. 13, users can freely transmit comparative reviews in the form of speech bubbles in the meeting room. The message window 282 may display transmitted comparative reviews 283a and 283b and include an icon 284 or a nickname of the participant. The comparative reviews 283a and 283b illustrated in the above example may be provided by the control method described in FIG. 12 or FIG. 20. Of course, the screen 280 may be configured to allow the comparative review to be input through a virtual keyboard.

In the present disclosure, the user can select and enter a meeting room classified as a single item or a comparison item. Respective items of the search result of FIG. 4 may include respective meeting rooms, and the ‘chats’ menu may be displayed as illustrated in FIG. 4 and the user may enter the meeting room by selecting the ‘chats’ menu.

The method of controlling the user computing device according to an embodiment of the present disclosure is characterized in that it is made to include providing a meeting room for exchanging messages for a single item or a comparison item, providing, by the user, at least one of a comparative preference, a comparative evaluation alone preference, and a product review as evaluation information in the meeting room, and displaying the provided information.

A method of displaying the comparative preference or rating on the meeting room according to the present disclosure will be described with reference to FIG. 13. A comparative preference 285 or rating transmitted from the user computing device may be displayed along with the icon 284 or message 283b of user. In the above example, the comparative preference 285 is displayed next to the icon 284. Since ‘(1) iPhone 13, (2) Galaxy S21’ is displayed in the title window 282, ‘(1)’ may designate ‘iPhone 13’ and ‘(2)’ may designate ‘Galaxy S21’ in the comparative preference. In the example, the comparative preference of the participant 284 is displayed as ‘(2)’, indicating that the participant prefers ‘Galaxy S21’. However, the comparative preference may be located at the end of the message 283b, etc. rather than next to the icon 284 of the user. Here, what is important is that the comparative preference is displayed on a portion corresponding to the transmitted message of the user. In contrast, in the case of the single item, the rating may be included instead of the comparative preference. That is, the rating input in the example of FIG. 9 may be displayed with a message instead of the comparative preference 285 of FIG. 13.

In the present disclosure, since the user computing device is only classified according to the type of use, the user may mean an evaluator, a participant, a purchaser, etc. For example, in the present disclosure, the user may be used as the evaluator, the participant, the purchaser, etc. in an ambiguous sense. In the present disclosure, a configuration in which payment is made immediately when the user makes a purchase in FIGS. 6 and 7 may be adopted.

In an embodiment of the present disclosure, in the Q&A room, classifying questions and answers and the questions and answers may be displayed separately.

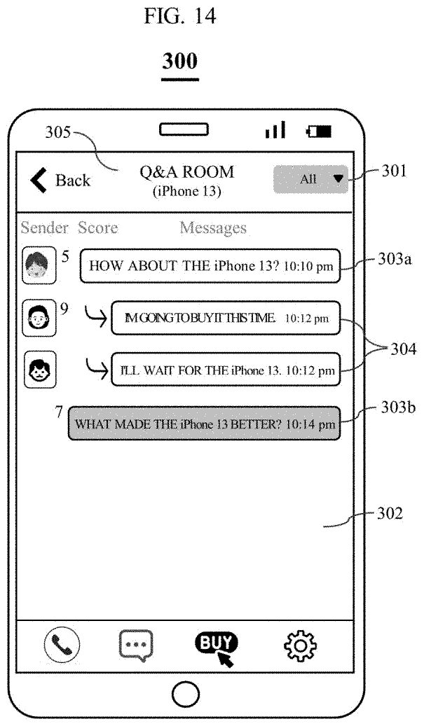

FIGS. 14 to 16 are examples of output screens 300, 310, and 320 for classifying questions and answers in the Q&A room according to an embodiment of the present disclosure.

FIG. 14 illustrates an example of the output screen 300 of the Q&A room among the meeting rooms according to an embodiment of the present disclosure.

The Q&A room may preferably include a title window 305 and a message window 302, such as an instant messenger, and ‘questions’, ‘answers’, and both (all) may be selected in the title window 305. The above example may include a selection button 301 (drop-down menu button) for this purpose. The ‘questions’ may be a question about the industrial product, and the ‘answers’ may be an answer to the ‘questions’.

In the above example, ‘all’ is selected as the selection button 301, and thus, the message window 302 illustrates both the questions and the answers for the industrial product ‘iPhone 13’ in the title window. The question can be made to show ‘answers’ which are answers that correspond to the question. In the above example, there are two ‘questions’ 303a and 303b and two ‘ answers’ 304. The two ‘answers’ are ‘answers’ 304 to the question ‘how about the iPhone 13?’ (303a).

The above example provides a Q&A room 305 for ‘iPhone 13’, but the present disclosure is not limited thereto, and a Q&A room for industrial products to be compared may be provided. For example, in the title window 305, ‘iPhone 13 vs. Galaxy S21’ may be displayed instead of ‘iPhone 13’ to provide answers and questions on the comparison of these two products.

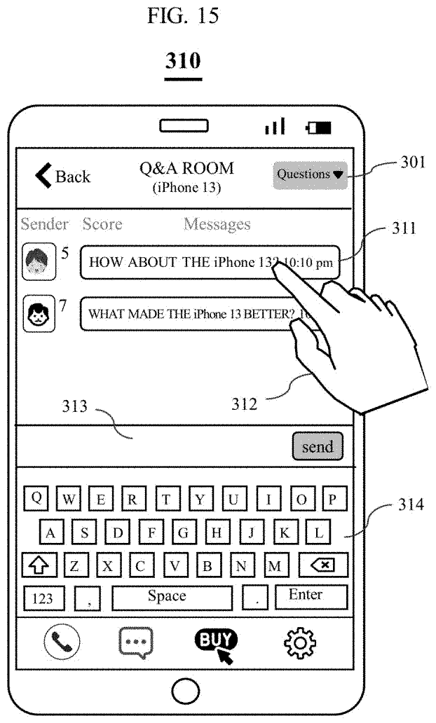

FIG. 15 is an example of the output screen 310 that classifies and illustrates only ‘questions’ in the Q&A room according to an embodiment of the present disclosure.

FIG. 15 is an output screen in a state in which ‘questions’ is selected from the selection button 301 of the title window. As in the above example, a new ‘questions’ can be input by including an input window 313 and a virtual keyboard 314 through which a new ‘questions’ can be input.

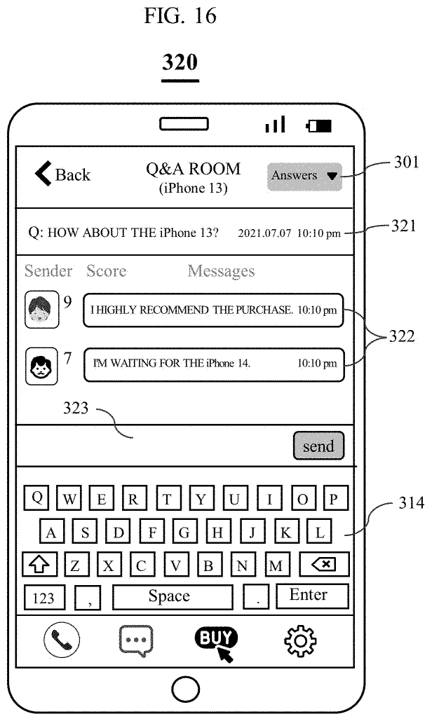

FIG. 15 illustrates that a user 312 selects ‘How about iPhone 13?’ (311), which is one of ‘questions’. When the ‘questions’ is selected, it may move to FIG. 16, which is the output screen 320 of ‘answers’ corresponding to the ‘questions’.

FIG. 16 is an example of the output screen 320 illustrating only answers in the Q&A room according to an embodiment of the present disclosure.

The screen 320 may be configured with a title window, a questions window 321, an input window 323, and a virtual keyboard 314.

In the questions window 321, the selected question, ‘How about iPhone 13?’ (311) may be displayed, and the selection button 301 of the title window may be automatically changed to ‘answers’. As in the example, in the message window, an ‘answers’ 322 corresponding to the questions window 321 may be displayed. The user may add a new ‘answers’ through the input window 323.

The control method according to an embodiment of the present disclosure may include including a predetermined industrial product and a comparative industrial product as a search result of the predetermined industrial product, receiving at least one of a comparative preference or a comparative review for the predetermined industrial product and the comparative industrial product or a plurality of comparative industrial products, and displaying the comparative preference or comparative review.

The above control method may include including a predetermined industrial product and a comparative industrial product as a search result of the predetermined industrial product, providing a meeting room for at least one of the predetermined industrial product or the comparative industrial product, and receiving and displaying at least one of single preference, comparative preference, product review, or comparative review for the predetermined industrial product or the comparative industrial product in the meeting room. In this specification, the industrial product may mean an industrial product or a predetermined industrial product in an ambiguous sense.

FIGS. 17 to 20 describe in detail a method of providing the comparative industrial product as a search result of the industrial product in the present disclosure.

FIGS. 17 to 20 are output screens 330-1, 330-2, 340 and 350 for displaying the predetermined industrial product and the comparative industrial product as search items as a search result of the predetermined industrial product according to an embodiment of the present disclosure.

FIG. 17 illustrate a screen 330-1 for outputting a predetermined industrial products and comparative industrial products as a result of inputting industrial product information (industrial product name) as a search keyword according to an embodiment of the present disclosure.

The above example is an output screen 330-1 which includes a search window 203 and a result window 333, and illustrates four search items 331-1 to 331-4 as a search result in the result window 333 when ‘iPhone 13’ is input as the search keyword in the search window 203 of the user computing device 53 and a search is performed.

Of the search result, the first search item is a single item because it includes one industrial product which is ‘iPhone 13’ 331-1. Of the search result, the second and third search items 333-2 and 331-3 are comparison items in which a predetermined industrial product is compared with comparative industrial products 331-2a and 331-3a, respectively, and the fourth search item 333-4 is a comparison item including three comparative industrial products 331-4a to be compared. For example, the second search item 333-2 is a comparison item including ‘iPhone 13’, which is a predetermined industrial product, and ‘Galaxy S21’ 331-2a, which is the comparative industrial product, as comparison targets. The search result window 333 may play the same role as the search result window 200 of FIG. 4. The contents described above with reference to FIGS. 3 to 9 may be equally applied to FIGS. 17 and 18.

The above example illustrates, as search items which are the search result, ‘iPhone 13’ 331-1, ‘iPhone 13 vs. Galaxy S21’ 331-2′, ‘iPhone 13 vs. Xiaomi Mi 11’ 331-3, ‘Galaxy S21 vs. iPhone 12 vs. the Galaxy Z Fold 3’ 331-4′ when a user inputs ‘iPhone 13’ as a search keyword. The fourth search item 331-4 is a comparison item and includes three industrial products as comparison targets, and thus the comparative information is displayed as a bar chart with three areas divided by comparative preference.

When a search keyword for a predetermined industrial product is input through the search window 203 of the user computing device 53, the computing device may derive, in response to the search keyword, a search result by performing a search for the predetermined industrial product and a comparative industrial product corresponding to the predetermined industrial product in the data storage computing device 51. That is, in response to the search keyword, among industrial products stored in the search information of the data storage computing device 51, not only a search for the predetermined industrial product but also a search for the comparative industrial product may be additionally performed.

In the result window of the search in response to the search keyword for the predetermined industrial product, a single item 331-1 including one single industrial product and comparison items 331-2 to 331-4 including at least one of comparative industrial products may be provided, as illustrated in FIG. 17.

As illustrated in FIG. 4, in the search result of the present disclosure, not only the search keyword ‘iPhone 13’ 203 but also the comparative industrial product ‘Galaxy S21’ 205-4 may be provided as a single item, which is a search item. In this case, the ‘Galaxy S21’ 205-4 may be included as a single item which is a comparative industrial product.

The result window 333 of the search according to an embodiment of the present disclosure is characterized in that it provides, as illustrated in FIG. 4, not only a search result for a predetermined industrial product that directly corresponds to the search keyword, but also at least one of comparative industrial products having the same as or similar to at least one of purpose of use or a main function with the search keyword, or corresponding to the search keyword. As described above, in the comparison items 331-2 to 331-4, a plurality of industrial products to be compared may be displayed in the item name, and a preference chart that is comparative information may be included in the item description. In particular, in the search result window 333 according to an embodiment of the present disclosure, a single item for a predetermined industrial product itself that directly corresponds to the search keyword may be output (e.g., output at the top or an indicator that distinguishes it from other search items, etc.) with the highest priority compared to other search items.

As in the output screen 330-1 illustrated in FIG. 17, by referring to the single item 331-1 and the comparison items 331-2 to 331-4 displayed as the search result, the user can easily receive at a glance not only the single preference of the industrial product, but also the comparative preference among a plurality of industrial products that has the same as or similar to at least one of purpose of use or a main function with the search keyword, or corresponding to the search keyword. In addition, detailed information may be provided in detail by selecting one of the above single item or comparison items.

Meanwhile, the search items provided as the search result may include a predetermined industrial product, and at least one of comparative industrial products or at least one comparative industrial product. As in the example illustrated, when ‘iPhone 13’ is searched, as the comparative industrial products, comparative industrial products corresponding to the predetermined industrial product in terms of at least one of a purpose of use or a main configuration, such as ‘Galaxy S21’ and ‘Xiaomi Mi 11’, and the number of comparative industrial products may be plural in one search item.

In this case, it is necessary to properly filter or sort the comparative industrial products in order to provide the user with the most appropriate comparison item. That is, this is to provide at least one of a comparison item between an industrial product and a comparative industrial product most likely of interest to the user, or a comparison item of a plurality of comparative industrial products. To this end, a placement algorithm such as placing a single item or comparison item selected a lot by the user at the top of the search result can be applied.

To this end, in one embodiment of the present disclosure, in order to provide the single item or comparison item most likely of interest to the use, the search result 333 may be derived by sorting or filtering the single item and the comparison item based on at least one of the number of registered single preference and comparative preference, the number of registered ratings and comparative reviews, and meeting room activity. For example, as in the example illustrated, if the number of registered comparative preferences for the industrial products of ‘iPhone 13’ and ‘Galaxy S21’ is the largest, it can be determined that they are the comparison targets of the highest interest from the consumer's point of view, and thus the industrial products can be provided (through sorting or filtering) with the highest priority.

On the other hand, in an embodiment of the present disclosure, information of a plurality of industrial products is received as the search keywords, and in response to this, a search result including a single item and comparison item for the industrial products and comparative industrial product may be provided. This embodiment will be described with reference to FIG. 18.

That is, in the present disclosure, providing at least one comparative industrial product as the search result of the predetermined industrial product (means information about the predetermined industrial product) may be at least one of processing and providing by the intermediary computing device or processing and providing by the user. For example, one or more comparative products corresponding to the the iPhone 13 in terms of at least one of a purpose of use or a main configuration may be provided from the intermediary computing device. Further, the present disclosure may provide a comparison item including at least one comparative industrial product that is not directly related to the search keyword, such as the fourth search item 331-4. As described above, in the present disclosure, by inputting information on the predetermined industrial product or information on the predetermined industrial product and the comparative industrial product as a search keyword, at least one of comparative industrial products having the same as or similar to a purpose of use or a main function with the search keyword, or corresponding to the search keyword may be included as a search result.

The greatest feature of the present invention is to include the comparative industrial product as the search result in response to industrial product information input as the search keyword. For example, if a search is performed with ‘iPhone 13’, the comparative industrial product such as ‘Galaxy S21 or ‘Xiaomi Mi 11’ may be included in the single item or the comparison item. For example, in the fourth item 331-4, the search keyword does not include ‘iPhone 13’ at all, but includes ‘Galaxy S21’, ‘iPhone 12’, and ‘Galaxy Z Fold 3’ as comparative industrial products. In this case, in this item 331-4, the name of the industrial product, which is the search keyword, is not included in the name of the comparison item at all. As such, the present disclosure is characterized in that a comparison item including at least one of comparative industrial products is provided in the search items of the comparison result.

FIG. 18 illustrates an example of the output screen 330-2 illustrating a search result, which is obtained by using two search keywords, as a search item according to the present disclosure.

The present disclosure is characterized in that it provides the data storage computing device 51 that is connected to the user computing device 53 and includes search information, the data storage computing device 51 including a communication unit exchanged data with the user computing device, a storage unit stores the search information, and a control unit performs a search using the search information, in which the control unit receives industrial product information about a predetermined industrial product as a search keyword from the user computing device, performs a search for the predetermined industrial product and a comparative industrial product of the predetermined industrial product, and provides a search result for the search keyword to the user computing device, the search result includes a search item including at least one of the comparative industrial products corresponding to the search keyword, and the comparative industrial product is an industrial product corresponding to the predetermined industrial product in terms of at least one of a purpose of use or a main configuration.

FIG. 18 illustrate the output screen 330-2 illustrating a search result for two search keywords according to an embodiment of the present invention.

In this example, ‘iPhone 13’ is input as a first search keyword 336-1, and ‘Galaxy S21’ is input as a second search keyword 336-2. The first and second search keywords 336-1 and 336-2 may be input separately by a preset search operator ‘+’. In other words, as in the illustrated example, the first and second search keywords 336-1 and 336-2 may be divided and input by a preset search operator (‘+’, etc.). As another example, the first and second search keywords 336-1 and 336-2, which include a single space, a comma (,), etc. as a search operator may be input. In addition, it is possible to performing a search by combining separated related words into one. For example, ‘iPhone 13’ can be searched as ‘iPhone13’ without a space.

In the user computing device 53 according to an embodiment of the present disclosure, based on or in response to the input of the first and second search keywords 336-1 and 336-2, with the aid of the data storage computing device 51, single items 337-1 and 337-2 including the first industrial product item 337-1 corresponding to the first search keyword 336-1 and the second industrial product item 337-2 corresponding to the second search keyword 336-2, or a single comparison item 337-3 including first and second industrial products items 336-1 and 336-2, or in addition to the first and second industrial products items 336-1 and 336-2, a single item 337-4 including ‘Xiaomi Mi 11’ which is another comparative industrial product, are included. As such, in the present disclosure, even if information about a plurality of industrial products is included as the search keyword, the single item or the comparison item may be included as a search result for other comparative industrial products, in response to the search keywords. As described above, the present disclosure can provide a search result in response to two or more search keywords. The detailed function of the comparison item 337-3 including the output comparison target at this time will be the same as described above with reference to FIGS. 11, 12, and 17. The item which is the search result may further include a comparative industrial product for the search keyword in addition to the first and second search keywords 336-1 and 336-2. The fourth search item 337-4 in the above example is a case in which only comparative industrial products for these search keywords 336-1 and 336-2 are included.

As illustrated in FIG. 18, the search items 337-1 to 337-4 displayed as the search result may be classified into respective meeting rooms. Accordingly, the data storage computing device or the user computing device may include the comparative preference room, the Q&A room or the free discussion room for the items as illustrated in FIG. 13. For example, if ‘chats (0.5k)’ included in an item description 337-2b of the example 330-2 is selected, it may be configured to allow the user to enter the meeting room. Of course, when selecting the item, it is possible to further include detailed information and select a meeting room 343 from the industrial product information collection.

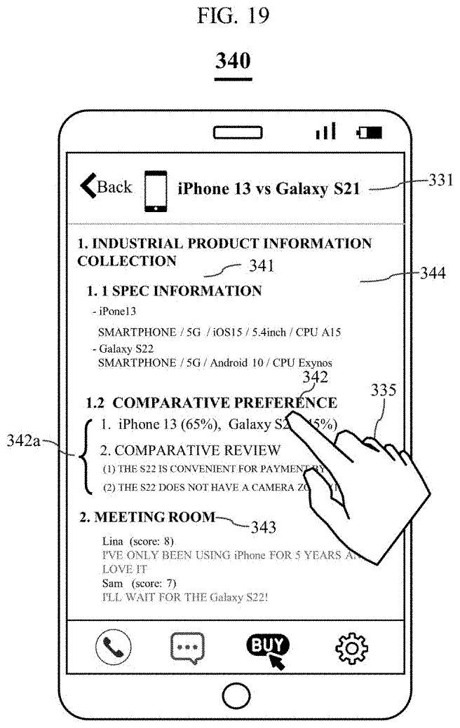

FIGS. 19 and 20 illustrate detailed information 340 and 350 as comparative information when ‘iPhone 13 vs Galaxy S21’ 337-3, which is a comparison item, is selected from among the items of the search result of FIG. 18. Accordingly, title windows 331 and 353 show the name 331 of the predetermined industrial product and the comparative industrial product included in the search item 337-3. Since these two industrial products are the same or corresponding to each other in terms of at least one of a purpose of use or a main configuration, the present disclosure may provide comparative preference and comparative review as comparative information for these industrial products.

FIG. 19 illustrates the output screen 340 of comparative information when the item 337-3 is selected according to an embodiment of the present disclosure.

In the output screen 340 illustrated in FIG. 19, when the user selects ‘iPhone 13 vs Galaxy S21’ 331-2, which are comparison items, from among the search items output as the search result in the result window 333 of FIG. 17 (332), a specification comparison 341, a comparative preference 342, and a meeting room 343, which are comparative information for the comparison items, are displayed. The comparative preference 342 may include at least one of detailed comparative preference or a comparative review for the comparative industrial product and the comparative industrial product which are comparison targets. The above examples include both the detailed comparative preference or comparative review.

The industrial product information collection may include the specification comparison 341 and the comparative preference 342, and when the comparative preference is selected, the output screen of FIG. 20 may be provided. The comparative preference 342 includes at least one of a comparative review 352 or detailed comparative preference 351. The detailed comparative preference 351 includes a preference chart 351a. The comparative preference chart 351a may include a percentage of comparative preference or a comparative preference chart for the preference of the industrial product and comparative industrial product.

As illustrated in FIG. 19 or 20, the present disclosure includes outputting, including at least one of the specification comparison, the comparative preference, or the comparative review, as comparative information between the industrial product and the comparative industrial product.

The example 340 plays the same role as the output screen 210 of the single information of the item described above in FIG. 5, but there is a difference in that comparative information to evaluate various industrial products to be compared, including only two industrial products, i.e., the industrial product and the comparative industrial product, is provided.

In FIG. 19, the output screen 340 is composed of the title window 331 and a result window 344. The result window 344 may include the specification comparison 341, the comparative preference 342, the meeting room 343, etc. as comparative information. This configuration is the same as the role of detailed information of the single item in FIG. 5. It differs only in whether it is an evaluation of one industrial product an evaluation of multiple industrial products. In the specification comparison, the specifications of the two industrial products 331 are compared and displayed, but when the area is selected, similarly to FIG. 8, information capable of comparing detailed specifications of two industrial products in detail may be further provided. As illustrated in FIG. 19, the comparative preference 342, which is comparative information, may include at least one of the detailed comparative preference or comparative review. The above example is a case in which both comparative preference and comparative review are included.

If the comparative preference 342 is selected, the output screen of FIG. 20 may be displayed. That is, in the example of FIG. 19, since the comparative preference 342 is simple comparative information 342a, when the comparative preference is selected, detailed comparative information 351 and 352 on the comparative preference and buttons or a method 351b, 352a, and 352c for inputting the comparative preference and comparative review may be included.

In addition, when the meeting room area 343 is selected, the user computing device 53 may output a meeting room in which messages can be exchanged with other participants. This is the same as those already described above with reference to FIGS. 13 to 16.

In particular, the meeting room that the user can enter by selecting the meeting room 343 may be a meeting room between participants who have selected the same comparison item (in the example illustrated, ‘iPhone 13’ and ‘Galaxy S21’ comparison items). That is, the meeting room may be for exchanging information about the topic of comparing ‘iPhone 13’ and ‘Galaxy S21’. This meeting room may include an Internet chat session. To this end, it will be apparent that the user computing device or the data storage computing device may separately create and maintain a meeting room for each of the items.

FIG. 20 illustrates the output screen 350 of the comparative preference and comparative review according to an embodiment of the present disclosure.

This example corresponds to the output screen 350 displayed when the comparative preference 342 of FIG. 19 is selected (335), and includes the detailed comparative preference 351 and the comparative review 352 that are comparative information about the two industrial products 353. In the detailed comparative preference 351, a chart 351a for the two industrial products 353 may be provided in the form of a visual graph, and a button 351b for the user to input a new comparative preference may also be included. Although the preference chart 351a is a bar graph for comparing two industrial products, like the fourth search item 331-4 in FIG. 17, in the comparative preference, a single bar chart or pie chart divided into multiple zones, or multiple bar charts can be displayed so that three or more industrial products can be compared. FIG. 20 has already been described in detail with reference to FIGS. 11 and 12 mentioned above.

As in the above example, the present disclosure is characterized in that it includes receiving at least one of the comparative information or the single information.

In the user computing device according to an embodiment of the present disclosure, as in the illustrated example, the comparative review 352 may include at least one comparative review 352b, and may include the button 352a for inputting a new comparative review. The comparative review according to an embodiment of the present disclosure may mean a comment on advantages and disadvantages or preferences of two or more industrial products to be compared. As in the example of FIG. 12, FIG. 20 may include the selection buttons 352b for selecting at least one of the existing comparative reviews 352b and the button 352a for inputting a new comparative review.

The control method according to an embodiment of the present disclosure may include processing the purchased industrial product to be delivered to a designated delivery destination from the user computer when the payment is processed.

A program capable of executing the control method according to the present disclosure may be stored in a recorded computer-readable recording medium.

As described above, an embodiment of a control method for classifying and and displaying email according to the present disclosure and a server for the same have been described. However, the embodiment is described as at least one embodiment, and the technical idea, configuration, and operation of the present disclosure are not limited by the embodiment. The scope of the technical idea of the present disclosure is not constrained/limited by the drawings or the description made by referring to the drawings. In addition, the concepts and embodiments of the invention presented in the present disclosure can be used by those of ordinary skill in the art as a basis for modifying or designing other structures in order to perform the same purpose of the present disclosure. Modified or changed equivalent structures by those of ordinary skill in the art to which the present disclosure pertains are bound by the technical idea of the present disclosure set forth in the claims, and various changes, substitutions, and alterations may be made thereto without departing from the spirit or scope of the invention set forth in the claims.

The effects of a computing device and a control method according to the present disclosure that provide single information or comparative information of a comparative industrial product by searching for a comparative industrial product that is not directly related by providing a predetermined industrial product as a search keyword are described as follows.

According to at least one of the embodiments of the present disclosure, there is an advantage in providing a computing device and a control method that provide search information for not only the industrial product to be purchased but also a related comparative industrial product when a user searches for the industrial product to be purchased.

The present invention has the advantage of providing information about not only the industrial product to be purchased but also a related comparative industrial product.

The present disclosure has the advantage of providing the comparative industrial product that is not directly related to the search keyword as a search result.

The present disclosure has the advantage of providing not only a search result for the industrial product that directly correspond to the search keyword, but also at least one comparative industrial product having the same as or similar to at least one of purpose of use or a main function with the search keyword, or corresponding to the search keyword.

The present disclosure has the advantage of providing single information or comparative information about comparative industrial products.

The present disclosure has the advantage of providing comparative information about an industrial product and a comparative industrial product or a plurality of comparative industrial products.

The present disclosure has the advantage of selecting and providing a product review or a comparative review that are previously input.

The present disclosure has the advantage of being able to effectively collecting and illustrating evaluations or opinions of various users about the industrial product and the comparative industrial product.

Although the data storage computing device for a keyword based search and control method for a user computing device have been described with reference to the specific embodiments, they are not limited thereto. Therefore, it will be readily understood by those skilled in the art that various modifications and changes can be made thereto without departing from the spirit and scope of the present invention defined by the appended claims.

What is claimed is:

1. A control method for a user computing device that is connected to a data storage computing device including search information and performs a keyword based search, the method comprising:
receiving industrial product information about a predetermined industrial product as the search keyword;
requesting the data storage computing device to search with the search keyword; and
receiving a search result for the search request from the data storage computing device, wherein
the search result includes a search item including at least one comparative industrial product corresponding to the search keyword,
the comparative industrial product is an industrial product corresponding to the predetermined industrial product in terms of at least one of a purpose of use or a main configuration,
the search item includes single information or comparative information,
the single information includes evaluation information for a single comparative industrial product, and
the comparative information includes evaluation information for comparing the predetermined industrial product with at least one of the comparative industrial products or a plurality of the comparative industrial products.

2. The method of claim 1, wherein
the industrial product information includes at least one of a name or a type or a specific category of the industrial product.

3. The method of claim 1, wherein
the comparative industrial product is included in a higher category or higher type of the predetermined industrial product.

4. The method of claim 1, wherein
the search item includes a comparative preference displayed in a form of a visual chart or chart, and
the comparative preference is evaluation information for comparing the preference of the predetermined industrial product with at least one of the comparative industrial products or a plurality of the comparative industrial products.

5. The method of claim 1, wherein
the single information includes at least one of specification information, a single preference, a product review, and a meeting room, and
the comparative information includes at least one of specification comparison, a comparative preference, a comparative review, and a meeting room.

6. The method of claim 5, further comprising:
receiving at least one of the comparative information or the single information.

7. The method of claim 5, wherein
the search result is derived by reflecting at least one of the single information or the comparative information.

8. The method of claim 5, further comprising:
outputting a meeting room where a message is exchanged with other participants.

9. The method of claim 8, wherein
the meeting room includes a message window that outputs the message of the participants of the meeting room in the form of a speech bubble, and
in the speech bubble of the participants, the preference input by the participant is also displayed.

10. A data storage computing device connected to a user computing device and including search information, comprising:
a communication unit configured to exchange data with the user computing device;
a storage unit configured to store the search information; and
a control unit configured to perform a search using the search information, wherein
the control unit is configured to
receive industrial product information about a predetermined industrial product as a search keyword from the user computing device,
perform a search for the predetermined industrial product and a comparative industrial product of the predetermined industrial product, and
provide a search result for the search keyword to the user computing device,
the search result includes a search item including at least one of the comparative industrial products corresponding to the search keyword,
the comparative industrial product is an industrial product corresponding to the predetermined industrial product in terms of at least one of a purpose of use or a main configuration,
the search item includes single information or comparative information,
the single information includes evaluation information for a single industrial product without a comparison target or a single comparative industrial product, and
the comparative information includes evaluation information for comparing the predetermined industrial product with at least one of the comparative industrial products or a plurality of the comparative industrial products.

11. The data storage computing device of claim 10, wherein
the comparative industrial product is included in a higher category or higher type of the predetermined industrial product.

12. A data storage computing device connected to a user computing device and storing search information, comprising:
a communication unit configured to exchange data with the user computing device;
a storage unit configured to store the search information; and
a control unit configured to perform a search using the search information, wherein
the control unit is configured to
receive industrial product information about each of an industrial product and a comparative industrial product as a search keyword from the user computing device,
perform a search for the search keyword,
provide a search result for the search keyword to the user computing device,
the search result includes a search item including at least one comparative industrial product corresponding to the search keyword,
the comparative industrial product is an industrial product corresponding to the predetermined industrial product in terms of at least one of a purpose of use or a main configuration,
the search item includes single information or comparative information,
the single information includes evaluation information for a single comparative industrial product, and
the comparative information includes evaluation information for comparing the predetermined industrial product with at least one of the comparative industrial products or a plurality of the comparative industrial products.
